(19) United States
(12) Patent Application Publication
(10) Pub. No.: US 2024/0333478 A1
(43) Pub. Date: Oct. 3, 2024

(54) QUANTUM-RESISTANT CRYPTOSYSTEM AND ELECTRONIC DEVICE INCLUDED IN THE SAME

(71) Applicant: INSTITUTE FOR BASIC SCIENCE, Daejeon (KR)

(72) Inventor: Kyung Ah SHIM, Daejeon (KR)

(73) Assignee: INSTITUTE FOR BASIC SCIENCE, Daejeon (KR)

(21) Appl. No.: 18/131,347

(22) Filed: Apr. 5, 2023

(30) Foreign Application Priority Data
Mar. 31, 2023 (KR) 10-2023-0042493

(51) Int. Cl. H04L 9/08; H04L 9/00

(52) U.S. Cl. CPC H04L 9/0825; H04L 9/002

(57) ABSTRACT

An electronic device included in a cryptosystem is disclosed. The electronic device comprising a communication device configured to communicate data, a memory configured to store a cryptographic program and a processor configured to control the electronic device to performs operations by executing the cryptographic program, wherein the operations include, receiving a public key of another electronic device from the another electronic device included in the cryptosystem, generating an electronic signature for the public key of the another electronic device and generating a public key certificate including the public key of the another electronic device, and the electronic signature, wherein the cryptographic program of the electronic device is a program applied to a cryptographic algorithm safe against to an attack based on a quantum computer.

### TECHNICAL FIELD

The present disclosure relates to a quantum-resistant cryptosystem and electronic device included in the cryptosystem.

### BACKGROUND ART

An electronic signature indicates the fact that a signer is identified and that the signer writes his/her signature on an electronic document, and refers to electronic information that, for later use, is attached to or logically combined with a specific electronic document.

A sender writes his/her electronic signature on a message using a cryptographic algorithm, and the electronic signature is verified by an electronic signature verification algorithm of a receiver.

In cryptography based on a public key, in a case where encryption and decryption are performed using an asymmetric key structure, a sender encrypts a message of receiver with a public key of the receiver and the receiver decrypts encrypted message with a private key of the receiver. Thus, confidentiality is provided. In a public-key-base electronic signature structure, the sender generates an electronic signature value on the message with his/her private key, and the receiver verifies the electronic signature value with a public key of the sender. Therefore, an authentication and non-repudiation function is provided.

### Technical Problem

An object of the present disclosure is to provide a quantum-resistant cryptosystem and electronic device included in the cryptosystem.

### Solution to Problem

An electronic device included in a cryptosystem according to an aspect of the present disclosure comprises a communication device configured to communicate data, a memory configured to store a cryptographic program and a processor configured to control the electronic device to performs operations by executing the cryptographic program, wherein the operations include: receiving a public key of another electronic device from the another electronic device included in the cryptosystem, generating an electronic signature for the public key of the another electronic device and generating a public key certificate including the public key of the another electronic device, and the electronic signature, wherein the cryptographic program of the electronic device is a program applied to a cryptographic algorithm safe against to an attack based on a quantum computer.

A cryptosystem according to an aspect of the present disclosure includes an upper subject and a lower subject, wherein the lower subject configured to store a lower subject cryptographic program, and generate a public key of the lower subject using the lower subject cryptographic program, wherein the upper subject configured to receive the public key of the lower subject from the lower subject, generate an electronic signature for the public key of the lower subject, and, generate a public key certificate including the public key of the lower subject, and the electronic signature, wherein the cryptographic program of the upper subject is a program applied to a cryptographic algorithm safe against to an attack based on a quantum computer.

### Advantageous Effects of Invention

A cryptosystem according to the embodiments of the present disclosure includes an upper subject and a lower subject, and the a cryptographic program used by the upper subject is based on a cryptographic algorithm safe against to attack based on a quantum computer. Thus, a security of the cryptosystem having hierarchical structure could be guaranteed. Especially, it is possible to deal with the attack based on the quantum computer more effectively.

### BRIEF DESCRIPTION OF DRAWINGS

Detailed descriptions of the drawings are provided to facilitate a more sufficient understanding of the drawings that are referred to under the section heading “Description of Embodiments.”

FIG. 1 is a block diagram illustrating a cryptosystem according to embodiments of the present disclosure.

FIG. 2 is a block diagram illustrating types of cryptograph programs that are used in the cryptosystem according to embodiments of the present disclosure.

FIG. 3 is a flowchart that is referred to for description of a process of storing in a lower subject the user public key certificate generated by the cryptosystem in FIG. 1.

FIG. 4 is a flowchart that is referred to for description of a process of storing the user public key certificate generated by the cryptosystem in FIG. 1 in a cloud storage.

FIG. 5 is a diagram for illustrating selection of cryptographic programs used in the cryptosystem according to embodiments of the present disclosure.

FIG. 6 is a block diagram illustrating another cryptosystem according to embodiments of the present disclosure.

### DESCRIPTION OF EMBODIMENTS

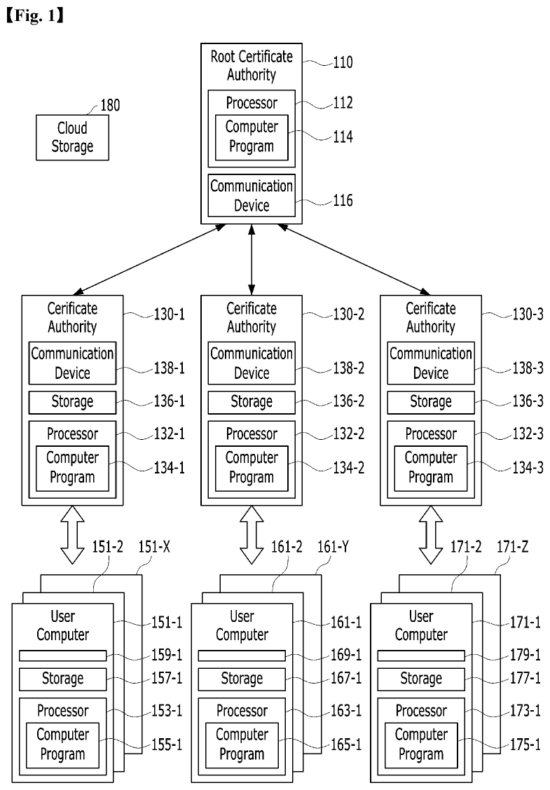

FIG. 1 is a block diagram illustrating a cryptosystem according to embodiments of the present disclosure.

With reference to FIG. 1, a cryptosystem 100 includes a root certificate authority 110, a plurality of certificate authorities 130-1 to 130-3, and a plurality of user computers 151-1 to 151-X, 161-1 to 161-Y, and 171-1 to 171-Z. X, Y, and Z that are referred to here are natural numbers that are equal to or greater than 2. According to the embodiments, the cryptosystem 100 may further include a cloud storage 180 that receives and stores a user public key certificate generated by the certificate authority 110, 130-1, 130-2, or 130-3.

An electronic signature described throughout the present specification is also referred to as a digital signature.

The certificate authorities 110 and 130-1 to 130-3, and a plurality of user computers 151-1 to 151-X, 161-1 to 161-Y, and 171-1 to 171-Z may be implemented as electronic devices including operation processing device (e.g. processor such as CPU) and communication device. For example, the electronic device is a server, a mobile terminal, or a computer, but is not limited thereto.

The certificate authorities 110 and 130-1 to 130-3, and a plurality of user computers 151-1 to 151-X, 161-1 to 161-Y, and 171-1 to 171-Z perform encryption and decryption by executing a cryptographic program stored in each of the certificate authorities 110 and 130-1 to 130-3, and a plurality of user computers 151-1 to 151-X, 161-1 to 161-Y, and 171-1 to 171-Z.

The cryptographic program may be a public key encryption program or electronic signature program, but is not limited thereto. The cryptographic program may be any program that performs cryptographic process such as converting a plaintext into cyphertext, and/or, a cyphertext into a plaintext.

For example, the cryptographic program may be a public key encryption program that generates a public key and secret key, encrypts a plaintext with the public/secret key and decrypt a cyphertext with the public/secret key. For example, the cryptographic program may be an electronic signature program that generates a public key and secret key, generates the electronic signature with the secret key and verifies the electronic signature with the public key.

The public key encryption program is a program based on cryptographic algorithm using a public key cryptography, such as, for example, a program based on a key encapsulation mechanism, a key distribution, a key agreement, a aggregate signature, a multi-signature, a homomorphic encryption, a functional encryption, or a functional signature.

According to the embodiments, the user computers 151-1 to 151-X, 161-1 to 161-Y, and 171-1 to 171-Z generate a key using a cryptographic program stored in the user computers 151-1 to 151-X, 161-1 to 161-Y, and 171-1 to 171-Z. The certificate authorities 110 and 130-1 to 130-3 verify validity of the key generated by the user computers 151-1 to 151-X, 161-1 to 161-Y, and 171-1 to 171-Z and generate a key certificate. For example, the key may be a public key and the key certificate may be a public key certificate.

According to the present disclosure, the certificate authorities 110 and 130-1 to 130-3 execute a cryptographic program safe against a attack that uses a quantum computer. The plurality of user computers 151-1 to 151-X, 161-1 to 161-Y, and 171-1 to 171-Z execute a cryptographic program safe or us-safe against a attack that uses a quantum computer.

The cryptographic program (also referred to as a “computer program”) described throughout the present specification is stored in a storage medium (for example, a storage) that is coupled to hardware (for example, a processor) and is thus readable by a computer (for example, a processor) and is executed by the computer.

Throughout the present specification, when a first cryptographic program installed on a first computer transmits and receives information (also referred to as a signal or data) to and from a second cryptographic program installed on a second computer, this means that the first cryptographic program transmits and receives the information to and from the second cryptographic program through a communication device of the first computer and a communication device of the second computer that are connected to each other through a communication network (for example, a wireless communication network or a wired communication network).

Each of the root (or high-level) certificate authority 110 and the plurality of certificate authorities 130-1 to 130-3 means a computer or server (also referred to as a “data processing device”).

The root certificate authority 110 includes a processor 112 that executes a cryptographic program 114, sand a communication device 116 that transmits and receives information to and from the certificate authority 130-1, 130-2, or 130-3 or the cloud storage 180 through the communication network.

A first certificate authority 130-1 includes a processor 132-1 that executes a cryptographic program 134-1, a storage 136-1, and a communication device 138-1 that transmits and receives information to and from the certificate authority 110, one of the user computers 151-1 to 151-X, and/or the cloud storage 180 through the communication network.

A second certificate authority 130-2 includes a processor 132-2 that executes a cryptographic program 134-2, a storage 136-2, and a communication device 138-2 that transmits and receives information to and from the certificate authority 110, one of the user computers 161-1 to 161-Y, and/or the cloud storage 180 through the communication network.

The third certificate authority 130-3 includes a processor 132-3 that executes a cryptographic program 134-3, a storage 136-3, and a communication device 138-3 that transmits and receives information to and from the certificate authority 110, one of the user computers 171-1 to 171-Z, and/or the cloud storage 180 through the communication network.

Each of the plurality of user computers 151-1 to 151-X, 161-1 to 161-Y, and 171-1 to 171-Z may be a PC or a mobile device, and examples of the mobile device include a laptop computer, a smartphone, a mobile Internet device (MID), an Internet-of-Things (IoT) device, and the like.

The user computer 151-1 includes a processor 153-1 that executes a cryptographic program 155-1, a storage 157-1, and a communication device 159-1 that transmits and receives information to and from the first certificate authority 130-1 through the communication network. It is assumed that a structure and operation of each of the user computers 151-2 to 151-X that transmit and receive information to and from the first certificate authority 130-1 through the communication network are the same as a structure and operation, respectively, of the user computer 151-1.

The user computer 161-1 includes a processor 163-1 that executes a cryptographic program 165-1, a storage 167-1, and a communication device 169-1 that transmits and receives information to and from the second certificate authority 130-2 through the communication network. It is assumed that a structure and operation of each of the user computers 161-2 to 161-Y that transmit and receive information to and from the second certificate authority 130-2 through the communication network are the same as a structure and operation, respectively, of the user computers 161-1.

The user computer 171-1 includes a processor 173-1 that executes a cryptographic program 175-1, a storage 177-1, and a communication device 179-1 that transmits and receives information to and from the third certificate authority 130-3 through the communication network. It is assumed that a structure and operation of each of the user computers 171-2 to 171-Z that transmit and receive information to and from the third certificate authority 130-3 through the communication network are the same as a structure and operation, respectively, of the user computer 171-1.

The communication network may be a wired communication network or a wireless communication network. Each of the storages 136-1, 136-2, and 136-3 may be a memory device and collectively refers to a volatile memory device and a nonvolatile memory device.

As illustrated in FIG. 1, the root certificate authority 110, the plurality of certificate authorities 130-1 to 130-3, and the plurality of user computers 151-1 to 151-X, 161-1 to 161-Y, and 171-1 to 171-Z have a hierarchy.

The root certificate authority 110 means an authority that issues and manages an electronic identification certificate of each of the certificate authorities 130-1 to 130-3. The first certificate authority 130-1 means an authority that issues and manages an electronic identification certificate of each of the user computers 151-1 to 151-X. The second certificate authority 130-2 means an authority that issues and manages an electronic identification certificate of each of the user computers 161-1 to 161-Y. The third certificate authority 130-3 means an authority that issues and manages an electronic identification certificate of each of the user computers 171-1 to 171-Z. According to the embodiments, the electronic identification certificate to a subject may mean a public key certificate that guarantees the validity of a public key generated by the subject, but is not limited thereto.

The root certificate authority 110 guarantees the validity of a public key of each of the certificate authorities 130-1 to 130-3. The first certificate authority 130-1 guarantees the validity of a public key of a user who uses each of the user computers 151-1 to 151-X. The second certificate authority 130-2 guarantees the validity of a public key of a user who uses each of the user computers 161-1 to 161-Y. The third certificate authority 130-3 guarantees the validity of a public key of a user who uses each of the user computers 171-1 to 171-Z. At this point, the guaranteeing of the validity of the public key means generation of the public key certificate, but is not limited to the generation thereof. The public key certificate may be generated by an electronic signature program.

Throughout the present specification, a subject of the cryptosystem that receives an electronic identification certificate is referred to as a lower subject, and a subject that issues and manages an electronic identification certificate of the lower subject is referred to as an upper subject. For example, the user computers 151-1 to 151-X, 161-1 to 161-Y, and 171-1 to 171-Z may be a lower subject against to the certificate authorities 110 and 130-1 to 130-3, and the certificate authorities 110 and 130-1 to 130-3 may be an upper subject against to the user computers 151-1 to 151-X, 161-1 to 161-Y, and 171-1 to 171-Z.

A lower subject cryptography computer program means a computer program that is executed on the lower subject, and an upper subject cryptographic program means a computer program that is executed on the upper cryptography.

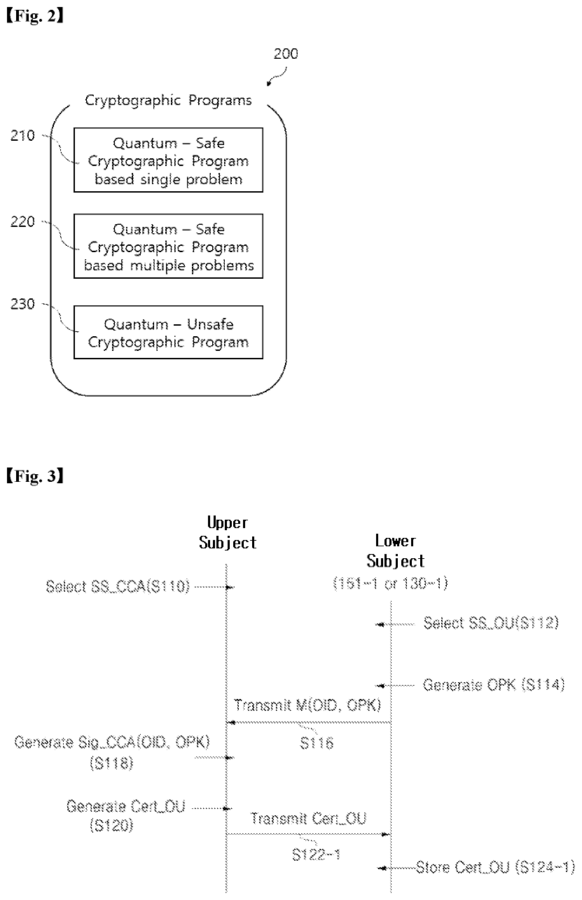

FIG. 2 is a block diagram illustrating types of cryptograph programs that are used in the cryptosystem according to embodiments of the present disclosure.

Throughout the present specification, a cryptographic program that is safe against an attack that uses a quantum computer means a computer program that uses (or executes) a cryptographic algorithm (also referred to as a quantum-resistant cryptography or a post quantum cryptography (PQC)) that is safe against the attack that uses the quantum computer. Moreover, a cryptographic program that is not safe against the attack that uses the quantum computer means a computer program that uses (or executes) the cryptographic algorithm that is not safe against the attack that uses the quantum computer.

At this point, the cryptographic algorithm is safe against an attack that uses a quantum computer means that no quantum computer-based algorithm (i.e., quantum algorithm) exists can solve the cryptographic algorithm within effective time, and vice versa. The effective time may be less than a polynomial time but is not limited thereto.

As illustrated in FIG. 2, cryptographic programs 200 are categorized into a first group 210, a second group 220 and a third group 230. Each of the group 210, 220 and 230 includes one or more cryptographic program.

The first group 210 and the second group 220 are sets of cryptographic programs that are considered as safe against the attack that uses the quantum computer. The third group 230 means a set of cryptographic programs that are considered as not safe against the attack that uses the quantum computer (e.g. cryptographic programs which have been used until now).

According to the embodiments, the first group 210 includes a lattice-based cryptographic program, a code-based cryptographic program, a multivariate quadratic-based cryptographic program, an isogeny-based cryptographic program, and a hash-based cryptographic program, but are not limited to these programs. For example, cryptographic programs included in the first group 210 may be a program using a cryptographic algorithm based on a single mathematical problem (i.e. difficulty of the problem).

The lattice-based cryptographic algorithm is a cryptographic algorithm based on the difficulty of a problem associated with a search for the shortest vector on a lattice. For example, the lattice-based cryptographic algorithm includes cryptographic algorithms based on problems of learning with errors (LWE), learning with roundings (LWR), a short integer solution (SIS), a ring LWE, a module LWE, and the like.

The code-based cryptographic algorithm is a cryptographic algorithm based on the difficulty of decoding a general linear code and includes cryptograph algorithm based on a syndrome decoding problem and the like. Examples of the code-based cryptographic algorithms include McEliece, modern McEliece, Niederreiter, MCPC-McEliece, wild McEliese, McBits, and the like.

The multivariate quadratic-based cryptographic algorithm is a cryptographic algorithm based on the difficulty of a problem to find a solution to a multivariate quadratic system defined on a finite field.

The isogeny-based cryptographic algorithm is a cryptographic algorithm based on the difficulty of a problem to find an isogeny present between two elliptic curves.

The hash-based cryptographic algorithm is a cryptographic algorithm based on the difficulty of a problem to find a collision or a second-preimage on a hash function.

In comparison to the second group 220, cryptographic programs included in the third group 230 may be a program using a cryptographic algorithm based on multiple mathematical problems (i.e. difficulty of the problems). Thus, if there exists an effective solution to a single problem that is basis of a cryptographic algorithm, a cryptographic program included in the first group 210 would be solved by the solution whereas a cryptographic program included in the second group 220 would not be solved by the solution.

According to the embodiments, the second group 220 includes a cryptographic program based on both a module-LWE problem and a module-SIS problem, and a cryptographic program based on both a multiple quadratic problem of multi-variable quadratic and an isomorphism of polynomial problem, but are not limited thereto.

The multiple problem that is basis of the programs of the third group 230 are problems of different types, or problems of different contents/solutions. A ring-LWE problem and a module-LWE problem correspond to the former. Ring-LWE problems for a ring Z[X]/Φ(X) or Z_{q}[X]/Φ(X) where Φ(X) are different correspond to the latter. Although there exists a security reduction between two problems, these two problems are still considered as different, and thus, they are to be basis of the programs of the second group 220.

According to the embodiments, the first group 210 includes an integer factorization problem-based cryptographic program, a discrete logarithm problem-based cryptographic program, and an elliptic-curve discrete logarithm problem-based cryptographic program, but are not limited to these programs.

According to the embodiments of the present disclosure, cryptographic programs stored in the certificate authorities 110 and 130-1 to 130-3 are included in the first group 210 or the second group 220, and cryptographic programs stored in the user computers 151-1 to 151-X, 161-1 to 161-Y, and 171-1 to 171-Z are included in the first group 210 to the third group 230.

FIG. 3 is a flowchart that is referred to for description of a process of storing in an lower subject the user public key certificate generated by the cryptosystem in FIG. 1.

At least one of the user computer 151-1 (or a user of the user computer 151-1), a first certificate authority 130-1 (or a manager of the first certificate authority 130-1), the root certificate authority 110 (or a manager of the root certificate authority 110), and a system engineer for the cryptosystem 100 may be a selection entity that selects the cryptographic program.

First, on the assumption that the lower subject is the user computer 151-1 and that the upper subject is the first certificate authority 130-1, a process of generating and managing a user certificate public key is described with reference to FIGS. 1 to 4.

The first certificate authority 130-1 selects a cryptographic program SS_CCA that is to be used by the first certificate authority 130-1 itself (S110). The first certificate authority 130-1 or the user of the user computer 151-1 may select a cryptographic program SS_OU that is to be used by the user computer 151-1 (S112).

A method of selecting the cryptographic program SS_OU to be used by the user computer 151-1 will be described below.

The cryptographic program 155-1 installed on the user computer 151-1 generates a public key OPK of the user (S114). At this time, the public key OPK and the secret key of the user are generated in a manner that constitutes a pair.

The cryptographic program 155-1 generates a message M (OID, OPK) that includes an identification information OID for uniquely identifying the user computer 151-1 (or the user of the user computer 151-1) and the public key OPK of the user) and transmits the generated message M to the first certificate authority 130-1 through the communication device (S116).

The cryptographic program 134-1 installed on the first certificate authority 130-1 generates an electronic signature Sig_CCA (OID, OPK) by the first certificate authority 130-1 for the identification information OID of the user and the public key OPK of the user (S118). For example, the cryptographic program 134-1 generates the electronic signature Sig_CCA(OID, OPK) by applying an electronic signature to the identification information OID and the public key OPK using a secret key of the first certificate authority 130-1 (S118).

Alternatively, the cryptographic program 13-41 installed on the first certificate authority 130-1 generates an electronic signature Sig_CCA (OID, OPK) by generating a pair of the public key OPK and a secret key for the user computer 151-1. At this point, the first certificate authority 130-1 can see (or recognize) the public key OPK, whereas cannot see (or recognize) the secret key.

The cryptographic program 134-1 generates a user public key certificate Cert_OU that includes the identification information OID, the public key (OPK) of the user, and the electronic signature Sig_CCA (OID, OPK)) (S210) and transmits the generated public key certificate Cert_OU to the user computer 151-1 (S122-1). The cryptographic program 155-1 receives the public key certificate Cert_OU and stores the received public key certificate Cert_OU in the storage 157-1 (S124-1).

On the assumption that a lower subject is the first certificate authority 130-1 and that an upper subject is the root certificate authority 110, a process of generating and managing a certificate public key of the first certificate authority 130-1 is described with reference to FIGS. 1 to 3.

The root certificate authority 110 selects the cryptographic program SS_CCA that is to be used by the root certificate authority 110 itself (S110), and a manager of the root certificate authority 110 or the first certificate authority 130-1 selects the cryptographic program SS_OU that is to be used by the first certificate authority 130-1 (S112).

The cryptographic program 134-1 installed on the first certificate authority 130-1 generates the public key OPK of the first certificate authority 130-1 (S114). At this point, the public key OPK and the secret key of the first certificate authority 130-1 are generated in a manner that constitutes a pair.

The cryptographic program 134-1 generates the message M (OID, OPK) that includes the identification information OID of the first certificate authority 130-1 or the manager of the first certificate authority 130-1 and the public key OPK of the first certificate authority 130-1, and transmits the generated message M (OID, OPK) to the root certificate authority 110 through the communication device (S116).

The cryptographic program 114 installed on the root certificate authority 110 generates the electronic signature Sig_CCA(OID, OPK) by the root certificate authority 110 for the identification information OID and the public key OPK of the first certificate authority 130-1 (S118). For example, the cryptographic program 114 applies an electronic signature to the identification information OID and the public key OPK with the secret key of the root certificate authority 110 and generates the electronic signature Sig_CCA (OID, OPK) (S118).

The cryptographic program 114 generates the public key certificate Cert_OU of the first certificate authority 130-1 (S210) that includes the identification information OID, and the public key OPK and the electronic signature Sig_CCA (OID, OPK) of the first certificate authority 130-1, and transmits the generated public key certificate Cert_OU to the first certificate authority 130-1 (S122-1). The cryptographic program 134-1 receives the public key certificate Cert_OU and stores the received public key certificate Cert_OU in the storage 136-1 (S124-1).

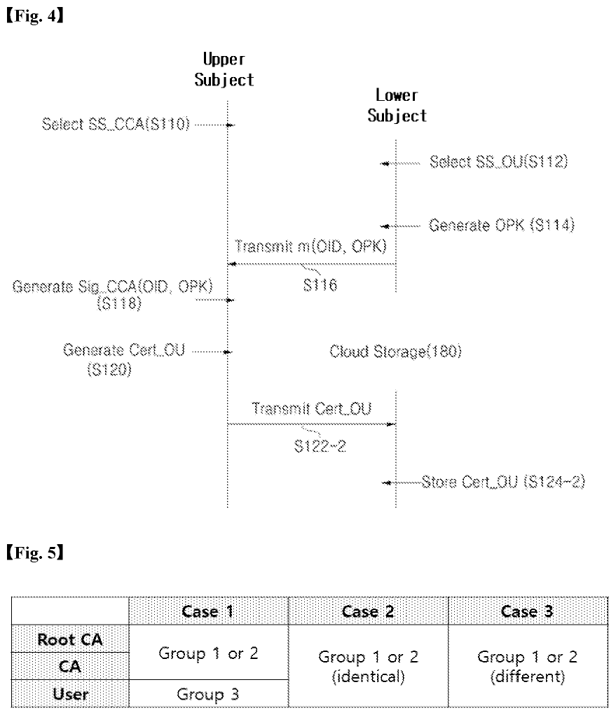

FIG. 4 is a flowchart that is referred to for description of a process of storing the user public key certificate generated by the cryptosystem in FIG. 1 in a cloud storage.

With reference to FIG. 3, the public key certificate Cert_OU of a lower subject that is generated by an upper subject (130-1 or 110) is stored in the lower subject 151-1 or 130-1. However, in FIG. 4, the public key certificate Cert_OU of the lower subject that is generated by the upper subject 130-1 or 110 is stored in the cloud storage 180 instead of being storing in the lower subject 151-1 or 130-1. Also, the public key certificate Cert_OU may be stored in other space than lower subject (151-1 or 130-1) or the cloud storage 180.

With reference to FIGS. 1 to 4, the cryptographic program 114 or 134-1 generates the public key certificate Cert_OU of an lower subject that includes the identification information OID, the public key OPK of the lower subject, and the electronic signature Sig_CCA(OID, OPK) (S120) and transmits the generated public key certificate Cert_OU to the cloud storage 180 (S122-2). The cloud storage 180 receives the public key certificate Cert_OU of the lower subject and stores the received the public key certificate Cert_OU therein (S124-2).

A method of performing an operation between the root certificate authority 110 and each of the certificate authorities 130-2 and 130-3 is the same as the method of performing the operation between the root certificate authority 110 and the first certificate authority 130-1, and thus a detailed description thereof is omitted. A method of performing an operation between each of the certificate authorities 130-2 and 130-3 and each of the user computers 161-1 to 161-Y and 171-1 to 171-Z is the same as the method of performing the operation between the first certificate authority 130-1 and each of the user computers 151-1 to 151-X, and thus a detailed description thereof is omitted.

FIG. 5 is a diagram for illustrating selection of cryptographic programs used in the cryptosystem according to embodiments of the present disclosure.

Referring to FIG. 5, cryptographic programs used in each of subject in the cryptosystem of the embodiments 110, 120-1˜120-3, 151-1˜151-X, 161-1 to 161-Y and 171-1 to 171-Z may be one or more cryptographic program included in the groups 210, 220 and 230.

According to the embodiments of the present disclosure, a cryptographic program used by a lower subject of the cryptosystem may be transmitted from an upper subject of the cryptosystem and installed in the lower subject. For example, in case of FIG. 1, a first certificate authority 130-1 may select a its cryptographic program from cryptographic programs of the groups 210, 220 and 230. Also, the first certificate authority 130-1 may transmit a cryptographic programs among the groups 210, 220 and 230 to the user computer 151-1. The transmitted cryptographic program is stored or installed in the user computer 151-1. At this point, the cryptographic program transmitted by the first certificate authority 130-1 may be determined by a request or selection of the user computer 151-1, or, a selection of the first certificate authority 130-1.

According to the embodiments of the present disclosure, cryptographic programs used in each of subject in the cryptosystem of the embodiments 110, 120-1˜120-3, 151-1˜151-X, 161-1 to 161-Y and 171-1 to 171-Z are determined according to CASE1 to CASE 3 as follows.

### Case 1

A cryptographic program used in the certificate authorities 110 and 130-1 are programs included in the first group 210 or the second group 220, and a cryptographic program used in the user computer 151-1 is a program included in the first group 210. For example, the certificate authorities 130 and 110-1 use a lattice-base cryptographic program based on both a module-LWE problem and a module-SIS problem, whereas the user computer 151-1 uses RSA cryptographic program based on a prime number factorization problem.

In case of CASE 1, the cryptographic program of the user computer 151-1 may be unsafe against to the attack based on the quantum computer. However, the cryptographic programs of the certificate authorities 110 and 130-1 are safe against to the attack. Thus, the cryptosystem has partial security against the attack. This manner can be used in transition period until achieving quantum-security.

### Case 2

Cryptographic programs used in the each of subject in the cryptosystem 110, 120-1˜120-3, 151-1˜151-X, 161-1 to 161-Y and 171-1 to 171-Z are included in the first group 210 or the second group 220, wherein the cryptographic programs have the same type of cryptographic programs (i.e., cryptographic programs based on the same type of the problems). For example, each of subject in the cryptosystem 110, 120-1˜120-3, 151-1˜151-X, 161-1 to 161-Y and 171-1 to 171-Z uses a multi-variable quadratic-base cryptographic program.

In case of CASE 2, the cryptographic program of the user computer 151-1 and the cryptographic programs of the certificate authorities 110 and 130-1 are all safe against to the attack. Thus, the whole cryptosystem is safe to against the attack based on the quantum computer.

### Case 3

Cryptographic programs used in the each of subject in the cryptosystem 110, 120-1˜120-3, 151-1˜151-X, 161-1 to 161-Y and 171-1 to 171-Z are included in the first group 210 or the second group 220, wherein each of the cryptographic program is different type of cryptographic programs from each other (i.e., cryptographic programs based on different type of the problems from each other). For example, the root certificate authority 110 uses a cryptographic program based on multi-variable quadratic, the certificate authority 110-1 use a lattice-base cryptographic program, and the user computer 151-1 uses a cryptographic program based on a hash function.

In CASE 3, problems that are basis of the cryptographic programs used in the each of subject in the cryptosystem 110, 120-1˜120-3, 151-1˜151-X, 161-1 to 161-Y and 171-1 to 171-Z do not share at least one problem. In other words, at least one problem (or type of the problem) that is basis of cryptographic programs of the subjects is not common. That is, problems that are basis of cryptographic programs of the subjects may have the same type except for at least one problem among them. For example, the root certificate authority 110 uses a cryptographic program based on both a module-LWE problem and a module-SIS problem, the certificate authority 110-1 use a cryptographic program based on both a ring-LWE problem and a ring-SIS problem, and the user computer 151-1 uses a cryptographic program based on both a module-LWE problem and a module-LWR problem.

In case of CASE 3, the cryptographic program of the user computer 151-1 and the cryptographic programs of the certificate authorities 110 and 130-1 are all safe against to the attack. In addition, in contrast to CASE 2, it can be prevented all cryptographic programs of the user computer 151-1 and the certificate authorities 110 and 130-1 from being solved by a single quantum algorithm.

According to the embodiments, a security level of the upper subject cryptographic program is not less than a security level of the lower subject cryptographic program in CASE 1 to CASE 3.

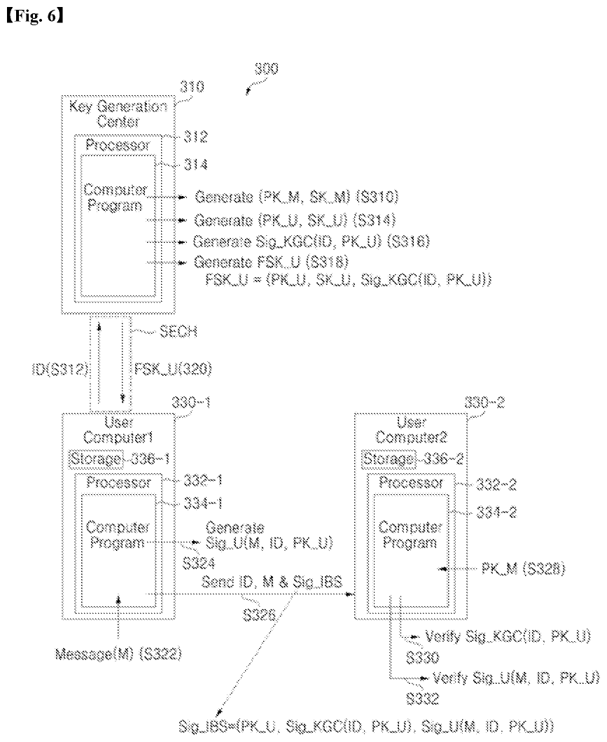

FIG. 6 is a block diagram illustrating a system performing a method of selecting a cryptographic program for design of an individual identification information-based cryptographic program according to embodiments of the present disclosure.

With reference to FIGS. 2 and 6, two electronic signature programs are necessary in order to design an identity information-based electronic signature scheme according to the embodiments of the present disclosure. The two electronic signature programs include an electronic signature program to be used by a key generation center (hereinafter referred to as a “KGC”) and an electronic signature program to be used by the user. The present invention is directed to a method of selecting the two electronic signature programs.

A cryptosystem 300 includes a KGC 310, a first user computer 330-1 and a second user computer 330-2. The KGC 310 may be a computer or a server (which may also be referred to as a “data processing apparatus”).

The KGC 310 includes a processor 312 that executes an electronic signature program 314 and a communication device that transmits and receives information to and from each of the user computers 330-1 and 330-2.

The first user computer 330-1 includes a processor 332-1 that executes an program 334-1, a storage 336-1, and a communication device that transmits and receives information to and from the KGC 310 and the second user computer 330-2 through the communication network.

The second user computer 330-2 includes a processor 332-2 that executes an program 334-2, a storage 336-2, and a communication device that transmits and receives information to and from the KGC 310 and the first user computer 330-1 through the communication network.

According to embodiments, the programs 334-1 and 334-2 of the user computer 330-1 and 330-2 may be a public key electronic signature program, and program 314 of the KGC 310 may be an electronic signature program.

When this method is used, two electronic signature programs (or algorithms) may be selected in such a manner as to satisfy efficiency requirements, such as an electronic signature length, a signature generation speed, and/or a signature verification speed of an individual identification information-based electronic signature program to be designed, and thus it is possible that each of the subjects 310, 330-1, and 330-2 is designed in a customized manner.

According to the embodiments, the programs 334-1 and 334-2 of the user computer 330-1 and 330-2 may be programs included in the first group 210 or the second group 220. The program 314 of the KGC 310 may be a program included in the first group 210 to the third group 230.

For example, a manner to select two cryptographic programs (i.e., electronic signature programs) used by each of the subjects 310, 330-1 and 330-2 is corresponding to CASE 1 of description with references to FIGS. 1 to 5. For example, the multivariate quadratic-based cryptographic program or the hash-based cryptographic program may be selected as the cryptographic program 314 to be used by the KGC 310, and the lattice-based cryptographic program is selected as the cryptographic programs 334-1 and 334-2 to be used by the user computer 330-1 and 330-2, respectively.

A method of designing an individual identification information-based cryptographic algorithm from a cryptographic algorithm based on the selected two public keys is described with reference to FIGS. 2, 3, and 6.

It is assumed that any one of the cryptographic programs 221 to 229 belonging to the second group 220 is selected as the cryptographic program 314 to be used by the KGC 310 and that the selected one and a different one of the cryptographic programs 221 to 229 belonging to the second group 220 are selected as the cryptographic programs 334-1 and 334-2 to be used by the user computers 330-1 and 330-2, respectively.

The key generation program that executes the key generation algorithm in a computer program 314 of the KGC 310 generates a pair (PK_M SK_M) of a KGC public key PK_M and a KGC secret key SK_M (S310).

When the key generation program of the computer program 314 receives first user identity information ID from a computer program 334-1 of the first user computer 330-1 (S312), the key generation program of the computer program 314 generates a pair (PK_U, SK_U) of a first user public key PK_U and a first user secret key SK_U using the first user identity information ID (S314).

The signature generation program that executes the signature generation algorithm in the computer program 314 of the KGC 310 generates a KGC electronic signature Sig_KGC (ID, PK_U) by applying an electronic signature to the first user identity information ID and the first user public key PK_U with the KGC secret key SK_M (S316).

The signature generation program of the computer program 314 generates a first user full secret key FSK_U=(PK_U, SK_U, Sig_KGC (ID, PK_U) that includes the pair (PK_U, SK_U) of the first user public key PK_U and the first user secret key SK_U, and the KGC electronic signature Sig_KGC (ID, PK_U) (S318), and transmits the generated first user full secret key FSK_U to the first user computer 330-1 through a secure channel SECH (S320). In terms of cryptography, the secure channel SECH means a means of transmitting data that guarantees integrity with impossibility of forgery and tamper.

The computer program 334-1 of the first user computer 330-1 receives the first user full secret key FSK_U=(PK_U, SK_U, Sig_KGC (ID, PK_U) and securely stores the received first user full secret key to the storage 336-1.

When a message M is input into the computer program 334-1 (S322), the signature generation program that executes the signature generation algorithm in the computer program 334-1 generates a first user electronic signature Sig_U (M, ID, PK_U) by applying the electronic signature to the message M, the first user identity information ID, and the first user public key PK_U with the first user secret key SK_U included in the first user full secret key FSK_U=(PK_U, SK_U, Sig_KGC (ID, PK_U) (S324).

The signature generation program of the computer program 334-1 generates a first user transmission electronic signature Sig_IBS=(PK_U, Sig_KGC (ID, PK_U), Sig_U (M, ID, PK_U)) that includes the pair (PK_U, SK_U) of the first user public key PK_U and the first user secret key SK_U, the KGC electronic signature Sig_KGC (ID, PK_U), and the first user electronic signature Sig_U (M, ID, PK_U), and transmits the first user identity information ID, the message M, and the first user transmission electronic signature Sig_IBS=(PK_U, Sig_KGC (ID, PK_U), Sig_U (M, ID, PK_U)) to the second user computer 330-2 (S326).

The verification program that executes the verification algorithm in a computer program 334-2 of the second user computer 330-2 acquires the KGC public key PK_M (S328). For example, the verification program of the computer program 334-2 may receive the KGC public key PK_M from the KGC 310.

The verification program of the computer program 334-2 verifies the KGC electronic signature Sig_KGC (ID, PK_U) using the KGC public key PK_M (S330). When as a result of the verification, it is determined that the KGC electronic signature Sig_KGC (ID, PK_U) is valid, the verification program of the computer program 334-2 performs the next step S332. When as a result of the verification, it is determined that the KGC electronic signature Sig_KGC (ID, PK_U) is not valid, the verification program of the computer program 334-2 rejects the first user transmission electronic signature Sig_IBS.

For example, the verification program may extract the first user public key PK_U, the KGC electronic signature Sig_KGC (ID, PK_U), and the first user electronic signature Sig_U (M, ID, PK_U) from the first user transmission electronic signature Sig_IBS=(PK_U, Sig_KGC(ID, PK_U), Sig_U(M, ID, PK_U).

The verification program of the computer program 334-2 verifies the first user electronic signature Sig_U(M, ID, PK_U) using the KGC public key PK_M (S332). When as a result of the verification, it is determined that the first user electronic signature Sig_U (M, ID, PK_U) is valid, the verification program of the computer program 334-2 approves the first user electronic signature Sig_U (M, ID, PK_U). When as a result of the verification, it is determined that the first user electronic signature Sig_U (M, ID, PK_U) is not valid, the verification program of the computer program 334-2 rejects the first user transmission electronic signature Sig_IBS.

In the public key certificate system 100 described with reference to FIGS. 1 to 5], the cryptographic algorithm (or the cryptographic program) has a structure in which the certificate authority-in-charge 110, 130-1, 130-2, or 130-3 that is a reliable authority issues and authenticates the public key certificate Cert_OU for the public key of the subject 130-1, 130-2, 130-3, one of 151-1 to 151-X, one of 161-1 to 161-Y, or one of 171-1 to 171-Z.

However, in the public key certificate system 300 described with reference to FIG. 6, with the individual identification information-based cryptographic algorithm (or the individual identification information-based cryptographic program), the KGC 310 generates a secret key of identity information ID of a user of the user computer 330-1 or 330-2 using the KGC secret key SK_M and transmits the generated secret key to the user computer 330-1 or 330-2 through the secure communication channel. The computer program that is executed by the user computer 330-1 or 330-2 generates and verifies the electronic signature Sig_IBS using individual identification information instead of using the public key certificate Cert_OU.

Therefore, the public key certificate system 300 described with reference to FIG. 6 does not include the certificate authorities 110, 130-1, 130-2, and 130-3 in FIG. 1 that guarantees the validity of the public key of the user.

The embodiments of the present disclosure are described with reference to the drawings, but only in an exemplary manner. It would be understandable by a person of ordinary skill in the art that various modifications are possibly made to the embodiments thereof and equivalents of the embodiments are possibly available. Therefore, the proper scope of the present disclosure should be determined by the technical idea defined in the following claims.

1. An electronic device included in a cryptosystem, the electronic device comprising:
a communication device configured to communicate data;
a memory configured to store a cryptographic program; and
a processor configured to control the electronic device to performs operations by executing the cryptographic program, wherein the operations include:
receiving a public key of another electronic device from the another electronic device included in the cryptosystem;
generating an electronic signature for the public key of the another electronic device; and
generating a public key certificate including the public key of the another electronic device, and the electronic signature,
wherein the cryptographic program of the electronic device is a program applied to a cryptographic algorithm safe against to an attack based on a quantum computer.

2. The electronic device of claim 1, wherein the cryptographic program of the electronic device is a program included in:
a first group which is a set of cryptographic programs applied to a cryptographic algorithm based on a single problem having security safe against the attack based on the quantum computer; or
a second group which is a set of cryptographic programs applied to a cryptographic algorithm based on multiple problems having security safe against the attack based on the quantum computer.

3. The electronic device of claim 2, wherein the cryptographic program of the another electronic device is a program included in:
the first group;
the second group; or
a third group which is a set of cryptographic programs applied to a cryptographic algorithm unsafe against to an attack based on a quantum computer.

4. The electronic device of claim 2, wherein the first group and the second group include at least one of:
a lattice-based cryptographic program, a code-based cryptographic program, a multivariate quadratic-based cryptographic program, an isogeny-based cryptographic program, and a hash-based cryptographic program.

5. A cryptosystem including an upper subject and a lower subject,
wherein the lower subject configured to:
store a lower subject cryptographic program, and
generate a public key of the lower subject using the lower subject cryptographic program,
wherein the upper subject configured to:
receive the public key of the lower subject from the lower subject,
generate an electronic signature for the public key of the lower subject, and,
generate a public key certificate including the public key of the lower subject, and the electronic signature,
wherein the cryptographic program of the upper subject is a program applied to a cryptographic algorithm safe against to an attack based on a quantum computer.

6. The cryptosystem of claim 5, wherein the cryptographic of the upper subject is included in:
a first group which is a set of cryptographic programs applied to a cryptographic algorithm based on a single problem having security safe against the attack based on the quantum computer; or
a second group which is a set of cryptographic programs applied to a cryptographic algorithm based on multiple problems having security safe against the attack based on the quantum computer.

7. The cryptosystem of claim 6, wherein the cryptographic program of the lower subject is a program included in:
the first group;
the second group; or
a third group which is a set of cryptographic programs applied to a cryptographic algorithm unsafe against to an attack based on a quantum computer.

8. The cryptosystem of claim 7, wherein the cryptographic program of the lower subject is a program included in the third group.

9. The cryptosystem of claim 7, wherein the cryptographic program of the lower subject is a program included in either the first group or the second group,
wherein cryptographic algorithms of cryptographic programs of the upper subject and the lower subject are all based on problems having the same type.

10. The cryptosystem of claim 7, wherein the cryptographic program of the lower subject is a program included in either the first group or the second group,
wherein at least one problem among problems that are basis of cryptographic algorithms of cryptographic programs of the upper subject and the lower subject is not common.
